(19) United States
(12) Patent Application Publication
(10) Pub. No.: US 2012/0111452 A1
(43) Pub. Date: May 10, 2012

(54) BLADE FOR TANGENTIAL SCRAPING OF A WORKPIECE SURFACE

(76) Inventor: Reinhard JORDAN, Purgstall (AT)

(21) Appl. No.: 12/940,097

(22) Filed: Nov. 5, 2010

(30) Foreign Application Priority Data
Nov. 5, 2010 (AT) A1755/2009

(51) Int. Cl. B27L 1/10

(52) U.S. Cl. 144/208.8

(57) ABSTRACT

In a scraping or debarking apparatus a blade and a workpiece having an outer surface to be scraped are relatively moved by rotation of the workpiece about an axis or orbiting of the blade about the axis such that the blade moves angularly relative to the surface. The blade has a body with a front side face turned radially generally toward the workpiece, a back side face turned away from the workpiece, and an edge face bridging the front and back faces and forming with the front face a corner. The body is oriented such that the corner is in engagement with the workpiece surface, and a strip of a material harder than a material of the body extends on the edge face along the corner.

### FIELD OF THE INVENTION

The present invention relates to a blade for tangentially scraping a workpiece surface. More particularly this invention concerns a blade for a debarking machine.

### BACKGROUND OF THE INVENTION

A typical debarking blade has a front face turned when in use toward the surface of the workpiece that is to be scraped and an edge face turned away from the surface to be scraped and that forms an acute angle with the side face and forms a cutting edge together with it, where at least one strip-shaped layer of hard material having a cutting edge is provided on the surface of the blade.

For removing bark from tree trunks, devices through which the tree trunks are passed are known. In this connection, multiple debarking blades mounted in radially movable arms strip the bark off the tree trunks tangentially. Over time, the cutting edges of such blades become dull, and the bark removal is no longer satisfactory, or can only be achieved by increasing the contact pressure of the arms against the trunk, which entails an increased demand for power.

In order to counteract overly rapid dulling and overly frequent blade replacement, it is known to provide the debarking blades with a strip of hard-material strip that has the cutting edge, along the cutting edge, on the face turned toward the tree trunk, so that the region of the cutting edge consists of a more resistant material. In this way, useful service lives of up to six weeks can be achieved.

### OBJECTS OF THE INVENTION

It is therefore an object of the present invention to provide an improved blade for tangential scraping of a workpiece surface, normally debarking that overcomes the above-given disadvantages, in particular that has a clearly increased useful is service life as compared with the prior art.

### SUMMARY OF THE INVENTION

In a scraping or debarking apparatus a blade and a workpiece having an outer surface to be scraped are relatively moved by rotation of the workpiece about an axis or orbiting of the blade about the axis such that the blade moves angularly relative to the surface. The blade has a body with a front side face turned radially generally toward the workpiece, a back side face turned away from the workpiece, and an edge face bridging the front and back faces and forming with the front face a corner. The body is oriented such that the corner is in engagement with the workpiece surface, and a strip of a material harder than a material of the body extends on the edge face along the corner.

In use of the blade, more rapid removal of the material is occurs in the region of the base body that borders on the hard-material strip than in the hard-material strip, on the surface of the blade that faces the surface to be scraped, thereby resulting in a self-sharpening effect that not only keeps the blade sharp but also makes it more aggressive over time. Therefore bark removal can take place at a constantly low contact pressure and therefore at a lower drive power, as compared with the prior art. Also, it is not necessary, as previously, to use different blades for summer operation and for winter operation. A blade according to the invention, having the dimensions of previous summer blades, can also be used in the winter, thereby resulting in simplifications in production and warehousing, and allowing costs to be saved. Tests have shown that a service life at least three to four times longer can be achieved with the blades according to the invention. After 20 weeks of use, the blade is in an ideal state, so that a useful service life of far more than 20 weeks can be expected.

According to a preferred embodiment, the width of the hard-material strip amounts to at least 4 mm, preferably between 6 and 12 mm.

It is advantageous if a second hard-material strip is provided on the end face, transverse to the cutting edge, on the rear end facing upstream in the travel direction of the workpiece. This second strip protects the edge of the blade that the arm of the device that presses the blade down guides into the correct radial position before the bark-removal process and therefore is also subject to great wear.

The thickness of this second hard-material strip particularly amounts to at most 4 mm, preferably between 1.5 and 2.0 mm, in order to avoid overly great rounding off in the region of the hard-material strip in the event of wear.

Either of the hard-material strips can be formed by a hard metal strip.

Alternatively, either of the hard-material strips can be formed by a matrix with embedded hard material particles.

It is advantageous if the edge face is perpendicular to the side face, which facilitates production.

In order to guarantee a better hold, the hard-material strip is welded onto the edge face.

### BRIEF DESCRIPTION OF THE DRAWING

The above and other objects, features, and advantages will become more readily apparent from the following description, reference being made to the accompanying drawing in which:

FIG. 1 is a schematic end view of a debarking machine;

FIG. 2 is a top view of a debarking blade according to the invention;

FIG. 3 is a side view of the debarking blade according to arrow III of FIG. 2;

FIG. 4 is a section through the debarking blade of FIG. 2 taken along line IV-IV of FIG. 2;

FIG. 5 is a view of the debarking blade of FIG. 2 taken in the direction of arrow V;

FIG. 6 shows a fresh debarking blade according to the invention in use;

FIG. 7 shows an fresh debarking blade according to the prior art in use in a view like FIG. 6;

FIG. 8 shows the debarking blade according to the invention with wear caused by use.

FIG. 9 shows the debarking blade of the prior art with wear caused by use.

### SPECIFIC DESCRIPTION

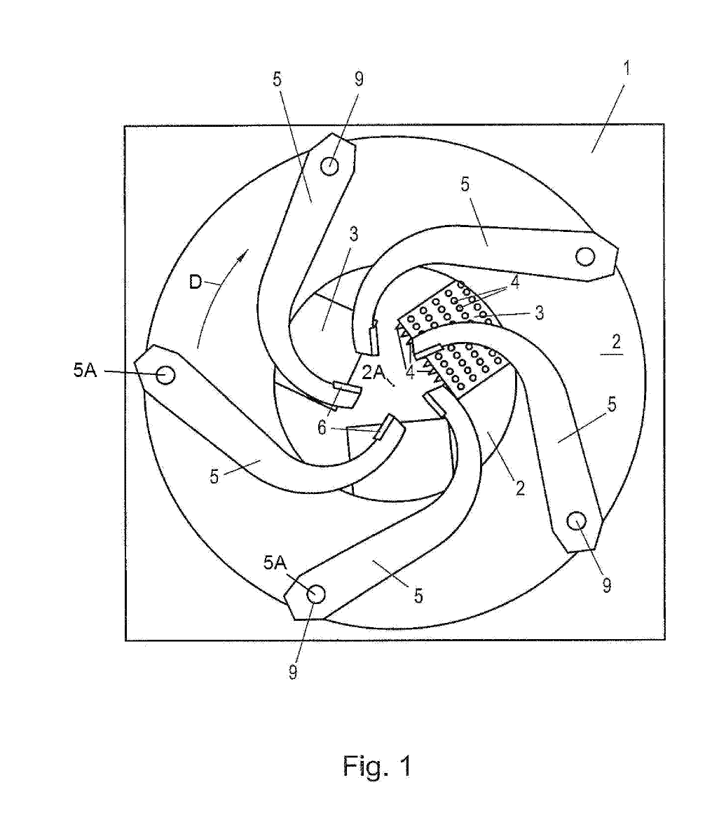

As seen in FIG. 1 a bark stripper has a frame or housing 1 holding a drum 22 rotatable in a direction D about an axis 2A and having a central axially through going opening 2. Two sets of three angularly equispaced conveying rollers 3 rotatable about axes tangential to the axis A and disposed axially in front of and behind the opening 2 can be displaced radially relative to the opening 2 (only the rear set of conveying rollers is shown). The rollers 3 are provided with spikes 4 on their outer surfaces to move the tree trunks 7 whose bark is to be stripped through the opening 2.

A plurality, here five, of identical arms 5 are mounted on the drum 22 angularly equispaced about the opening 2 and pivotal at outer ends on shafts 9 defining pivot axes 5A parallel the axis 2A. Inner ends of the arms 5 are biased to extend inward into axial alignment with the opening 2 and carry debarking blades 6. When a tree trunk 7 is pushed through the opening 2 against the arms 5, using the rear conveying rollers 3, the axially rearwardly directed edge faces 8 of the debarking blades 6 are engaged by the end of the tree trunk 7 and pivot the arms 5 radially outward until the blades 6 lie against the outer surface of the tree trunk 7. The contact pressure of the debarking blades 6 on the tree trunk 7 is controlled by a biasing torque applied to the shafts 9 carrying the arms 5.

Cutting edges 21 of the debarking blades 6 are thus pressed radially inward against the outer surface of the tree trunk 7 in accordance with the contact pressure and remove bark 11 of the tree trunk 7 in a spiral as the drum 22 rotates and the tree trunk 7 advances axially. Alternately, the pivot axes 5A of the arms 5 with the blades 6 can be mounted directly on the body 1 and the tree trunk 7 can be both rotated about its axis as it is conveyed axially through the opening 2.

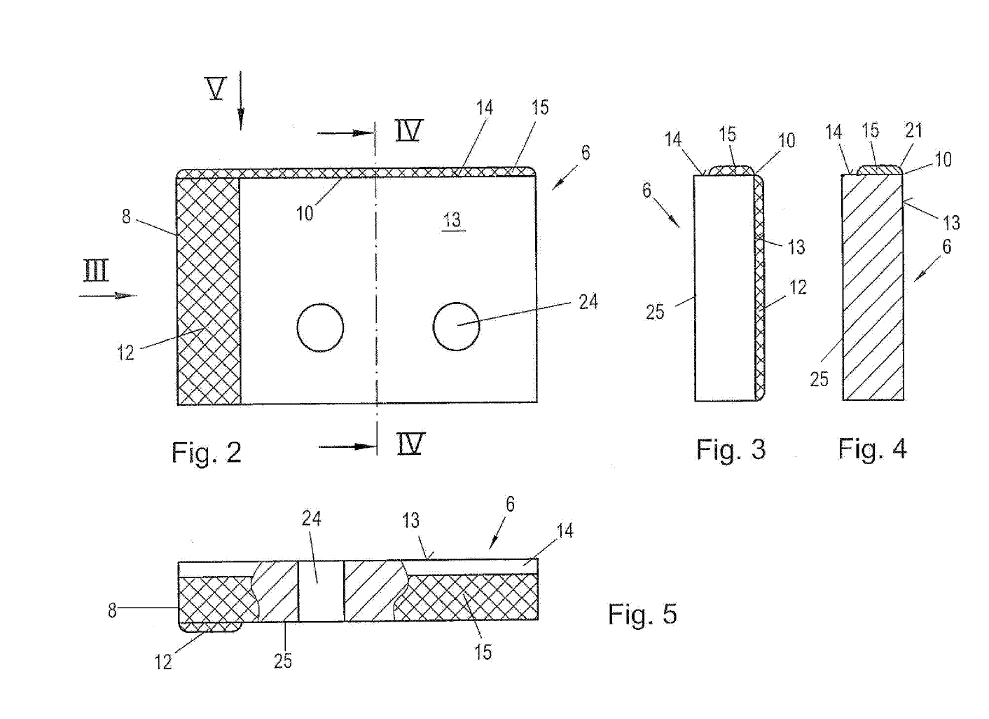

FIGS. 2 to 5 show a blade 6 according to the invention fitted into an arm 5 in the machine shown in FIG. 1. The blade 6 has a front side face 13, a back side face 25 parallel thereto, and an edge face 14 bridging the front and back faces 13 and 25 and forming a right-angle corner 10 with the front face 13. A hard-material strip 15 having the cutting edge 21 is provided on the edge face 14 that is turned away from the bark 11 of the tree trunk 7 in use. On its front side face 13 turned toward the bark 11 on the tree trunk 7, in use, the blade 6 has a strip 12 of hard material along the rear or upstream edge face 8, in the travel direction of the tree trunk 7. This edge face 8, which runs transverse to the axis of the tree trunk 7 and faces the opening 2 in the machine of FIG. 1, serves, as has already been explained in connection with FIG. 1, for moving the arms 5 radially outward when a new tree trunk 7 is fed in, and bark removal begins after this has happened. Since this edge 8 is also subject to great wear, it is practical to provide the hard-material strip 12 in order to increase the service life of the blade 6. The hard-material strip 12 also prevents erosion of the material of the body 20 of the blade 6 under the hard-material strip 15, and thus breakage of this material. Bores 24 serve for attaching the blades 6 to the respective arms 5 of the machine of FIG. 1.

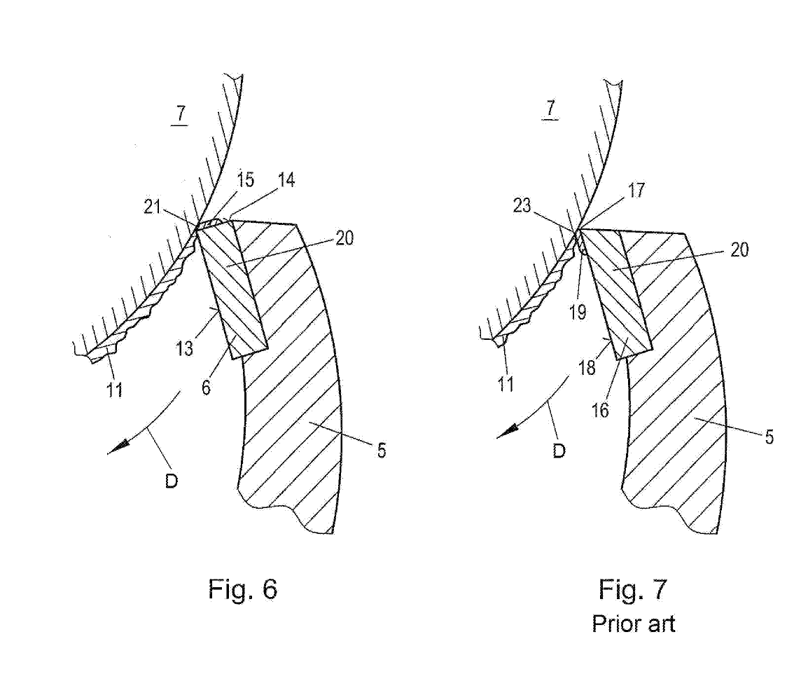

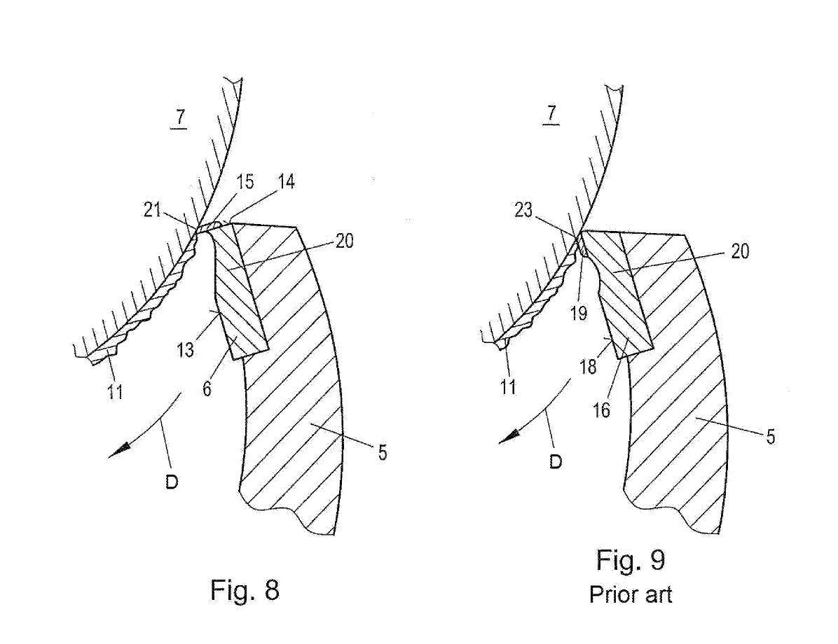

In FIGS. 6 to 9, the tree trunk 7 whose bark 11 has already been partly removed is shown along with one of the arms 5 that move relative to the log 7 in the direction D. The blades 6 according to the invention (FIGS. 6 and 8) and 16 according to the prior art (FIGS. 7 and 9) lie against the tree trunk 7 with their respective cutting edges 21 and 23 at a specific contact pressure, so that when the tree trunk 7 is rotated, the cutting edges 21 and 23 strip off the bark 11.

The blade 6 according to the invention has the hard-material strip 15 forming the cutting edge 21 along the corner 10, on its edge face 14 turned away from the bark 11. The blade 16 of the prior art has a hard-material strip 19 forming the cutting edge 23 on its side face 18 turned toward the bark 11, running along a corner 17 of the base body. Rapid dulling of the blades is prevented by the formation of the cutting edges 21 and 23 in the hard-material strips 15 and 19.

After several weeks of use, clear wear phenomena can be seen on the blades 6 and 16, as shown in FIGS. 8 and 9. The hard-material strips 15 are 19 are also subject to wear. But above all, the softer material of the base bodies 20 of the blades 6, 16 is worn away.

FIG. 9 shows that in the case of the prior-art blade 16, because of the lesser wear of the hard-material strip 19, the material of the base body 20 that lies adjacent it has been worn away, and the radius of the cutting edge 23 has clearly increased, i.e. the blade 16 has become dull. For the length of the useful service life, it is therefore important, in the case of the blade 16 according to the prior art, that the surfaces 14 and 18 that form the corner 17 form an acute angle with one another. However, for stability reasons, the size of the angle has a lower limit, and the production of the cutting edge 17 with an acute angle is complicated.

FIG. 8 shows that in the case of the blade 6 of the present invention, some wear of the hard-material strip 15 has also taken place. However, far greater material removal has taken place in the material of the base body 20, underneath the hard-material strip 15. Because of the material removal of the base body 20, a self-sharpening effect occurs, as the result of which the blade 6 is actually sharper than when new. Rounding off of the cutting edge 21 is restricted by the thickness of the hard-material strip 15, which therefore should not be greater than 4 mm and preferably should amount to between 1.5 and 2 mm. In the case of the prior-art blade 16, even though removal of the material of the base body 20 can also occur on the face 18 underneath the hard-material strip 19 and turned toward the bark 11, no self-sharpening effect occurs due to the geometric placement of the hard-material strip 19

I claim:

1. In an apparatus wherein a blade and a workpiece having an outer surface to be scraped are relatively moved such that, as a result of rotation of the workpiece about an axis or orbiting of the blade about the axis, the blade moves angularly relative to the surface the improvement where the blade comprises:
a body with a front side face turned radially generally toward the workpiece, a back side face turned away from the workpiece, and an edge face bridging the front and back faces and forming with the front face a corner, the body being oriented such that the corner is in engagement with the workpiece surface; and
a strip of a material harder than a material of the body extending on the edge face along the corner.

2. The improvement defined in claim 1 wherein the strip has a width measured parallel to the edge face of at least 4 mm.

3. The improvement defined in claim 2 wherein the width is between 6 mm and 12 mm.

4. The improvement defined in claim 2 wherein the strip has a thickness measured perpendicular to the edge face of at most 4 mm.

5. The improvement defined in claim 4 wherein the thickness is between 1.5 and 2.0 mm.

6. The improvement defined in claim 1 wherein the strip is of hard metal.

7. The improvement defined in claim 1 wherein the strip is formed by a matrix in which hard particles are embedded.

8. The improvement defined in claim 1 wherein the edge face and front face extend are substantially perpendicular to each other.

9. The improvement defined in claim 1 wherein the strip is welded onto the edge face.

10. The improvement defined in claim 1 wherein the workpiece and blade are moved relatively axially and blade further comprises
a second strip of a material harder than the material of the body extending on the front face generally perpendicular to the corner along one end face of the blade facing upstream in the relative axial movement direction.

11. The improvement defined in claim 10 wherein the second strip has a width measured parallel to the front face of at least 4 mm.

12. The improvement defined in claim 10 wherein the width is between 6 mm and 12 mm.

13. The improvement defined in claim 10 wherein the second strip has a thickness measured perpendicular to the front face of at most 4 mm.

14. The improvement defined in claim 10 wherein the thickness is between 1.5 and 2.0 mm.

15. The improvement defined in claim 10 wherein the second strip is of hard metal.

16. The improvement defined in claim 10 wherein the second strip is formed by a matrix in which hard particles are embedded.

17. The improvement defined in claim 1 wherein the strip is welded onto the front face.
